(19) United States
(12) Patent Application Publication
(10) Pub. No.: US 2006/0266173 A1
(43) Pub. Date: Nov. 30, 2006

(54) Impact cutting device and cutting unit therefor

(76) Inventor: Helmut Schuster, Denklingen (DE)

Correspondence Address: SCHNECK & SCHNECK, P.O. BOX 2-E, SAN JOSE, CA, 95109-0005, US

(21) Appl. No.: 10/547,739

(22) PCT Filed: Mar. 4, 2003
(86) PCT No.: PCT/EP03/02177

§ 371 Date: Sep. 1, 2005

(51) Int. Cl. B26D 1/00

(52) U.S. Cl. 83/13

(57) ABSTRACT

The invention relates to an impact cutting device (1) comprising a cutting unit (10) for processing workpieces, an acceleration unit (30) and an impact element (21) that can be accelerated towards the cutting unit (10). According to the invention, the impact element (21) and the acceleration unit (30) are detachably coupled to each other, wherein the impact element (21) can be decoupled from the acceleration unit after having been accelerated by the acceleration unit (30) and prior to striking the cutting unit (10). Further, a cutting unit (10) having a damping element is proposed for this impact cutting device.

The invention refers to an impact cutting device for adiabatic separation of workpieces, a cutting unit for an impact cutting device as well as a method for accelerating an impact element in an impact cutting device.

During high-speed impact cutting a high impulse is imparted to a moveable matrix being laterally displaced along a stationary matrix by means of the impulse. The workpiece is clamped between the matrices in a passage through the matrices, wherein their cross-section corresponds to the cross-section of the workpiece to be separated. Observations show that the workpiece to be cut can be separated almost without plastic deformation by very short, but heavily interacting impulse. Thereby the displaceable matrix is displaced by only few tenths of millimeters relative to the stationary matrix. Herein it is problematic on the one side to transmit a reproducible impulse of accurate power to the moveable matrix, and on the other side to damp the impulse energy, which has not been transformed into separation energy, in such a manner that the impact cutting device is also applicable for permanent use.

DE 695 19 238 T2 (corresponding to EP 0 833 714 B1) describes an impact machine, in which the workpiece is clamped between a stationary and a moveable matrix. On the stationary matrix rests an impact bolt, onto which an impact impulse is transmitted by means of a hydraulically moved piston. It is the object herein to achieve a cutting rate as high as possible, so that for example a high cutting rate for wire nails of a certain length is achieved. In order to achieve the high cutting rate by means of the hydraulically operated piston a particular piston/cylinder arrangement is proposed.

Also U.S. Pat. No. 4,840,236 suggests a hydraulic-pneumatic actuator for transmitting high impulses to a workpiece to be compressed or cut. Besides a cylinder arrangement for a high acceleration of the piston also an arrangement for slowing down the piston is proposed.

It is an object of the invention to provide an impact cutting device and a method therefor, in which the acceleration of an impact element may be accurately set and the impact impulses minimally affect the acceleration device.

This object is achieved by the features of claims 1, 25 and 32. Advantageous embodiments are subject matter of the dependent claims.

The conventional impact cutters are optimized to separate a workpiece (mostly in form of a wire and being of a specific basic material having a given thickness) by a very high impact rate so that many wire nails can be produced for further processing. When rigging the machine, the system is optimized by tests in that on the one side a clear material separation is carried out and on the other side there is a preferably low transformation of the impact impulse into shock waves within the apparatus. The optimization time is justified by means of the subsequently long use of the machine with the optimized parameters. Such an optimization phase is however not justified for frequently changing workpiece types (form of material, thickness of material, used material etc.). Therefore it is aspired to achieve a change in the impulse of the impact element and the optimization of the impact energy in a manner as simple and reproducible as possible. Due to the dynamic processes in a pneumatic or hydraulic system this is very extensive and depends on the oil temperature, on the oil type, its contamination, the wear of sealing elements and the like. Further, in conventional impact cutters the moving impact element and the acceleration element are connected to each other also during the impact phase so that on the one hand the acceleration device has to be correspondingly mechanically stable and on the other hand undergoes a strong mechanic stress, which may result in a fast wear.

In the impact cutting device according to claim 1 it is proposed that the impact element transmitting the impulse to an impact unit is releaseably coupled to an acceleration unit. Before the impact element impinges on the cutting unit a decoupling between the acceleration unit and the impact element is carried out by a coupling device. By decoupling the operations ‘impacting’ and ‘accelerating’ the impact process and the acceleration process can be optimized independently from each other, wherein, particularly by decoupling the acceleration unit from impacting, the acceleration unit undergoes considerably lower mechanical stress. Further, the acceleration may be interrupted exactly then, when the impact element has the impulse required for the workpiece to be processed, so that e.g. the slowing down of the acceleration unit in turn has no effect on the impact element and its impulse. By means of the forceless ‘flight path’ of the impact element when approaching the cutting unit also an exact adjustment between the acceleration unit and the cutting unit is not necessary for reproducing a given impact impulse.

A carrier of the acceleration unit advantageously grips into the impact element and carries this at least during the acceleration phase and over the acceleration distance, respectively. Via the carrier on the one hand the acceleration power is transmitted to the impact element and on the other hand a secure guiding of the impact element is achieved. The coupling ‘at least’ over an acceleration distance means herein that either the carrier is coupled to the impact element only during the acceleration phase and over the acceleration distance, respectively, and directly after the acceleration a decoupling takes place. Or a coupling is maintained for another given time and distance, respectively, after the acceleration, so that the carrier couples to the impact element free of force. In this phase the system of the impact element/acceleration unit may relax free of force on the one hand and on the other hand the carrier may be decoupled from the impact element by minimizing the frictional forces or the like.

A guiding of the carrier advantageously runs at least over the acceleration distance parallel to the track of the impact element so that no offset between the carrier and the impact element is necessary over the acceleration distance and the acceleration phase, respectively. In a particularly advantageous embodiment the carrier is decoupled from the impact element in that the track of the carrier deviates from the track of the impact element after the acceleration distance and, if applicable, a relaxation distance. Thereby the carrier and the impact element are spatially separated from each other and by means of a spatial separation of the impact element from the cutting unit an interaction between those two is excluded during the impact phase.

If the carrier is arranged on a strip- or cordlike element the carrier may be accelerated by means of pulling and, if applicable, pushing on the strip- or cordlike element. Further, the track of the carrier may be easily changed by deflecting the strip- or cordlike element. The striplike element is advantageously a belt, for example a tooth belt, or a chain, which may transfer high acceleration and pulling forces, respectively, to the carrier.

If the striplike element is endless and guided over at least two deflecting elements, a nearly constant stress is enabled by means of the striplike element, when the striplike element is uniformly driven—nearly independent of the position of the carrier. The striplike element is in particular advantageously driven by at least one of the deflecting elements so that the construction of the acceleration device is simplified.

If the impact element comprises a recess for supporting the carrier and if a ramp element is adjacent to the recess, the carrier may be traced back into the recession over the ramp by means of lateral deflection of the carrier when retracting the carrier. After decoupling and carrying out the impact to the cutting device, it is thus enabled that by means of easily feeding the carrier into the recession the carrier is re-coupled to the impact element and then the impact element may be retracted in reverse acceleration direction in the original or a new position. For example, the carrier is arranged on a striplike element and when traveling the ramp the carrier is displaced laterally to the impact element by perpendicularly retracting the carrier to the acceleration direction, until it re-engages with the recess. The inverse embodiment may of course be provided in which the carrier comprises a recess and a protruding element of the impact element engages with the recess of the carrier.

If the coupling of the impact element and the acceleration unit comprises several coupling locations and if these are symmetrically arranged as regards the acceleration direction, a tilt moment due to the acceleration power on the impact element is prevented during the acceleration.

If the impact element is guided in a guiding device during its movement towards the cutting unit, a sliding element reduces the friction when guiding along the guiding device. If the sliding element is moveably supported in a recession on the impact element, decoupling is provided between the impact vibration when the impact element impinges on the cutting device. Additionally, a damping element is advantageously arranged between the moveable sliding element and the impact element so that the vibration movement is not directly transmitted from the impact element to the guiding device of the impact element. Alternatively and/or additionally the cutting unit is supported on a mineral cast support structure for vibration damping. The mineral cast shows excellent damping features and reduces the shock propagation to the workhall floor or the acceleration unit.

In particular two impact elements are advantageously accelerated from opposite directions to the cutting unit and impinge on it. If the cutting unit comprises for example two moveable matrix elements, which are vibrantly supported, the two impulses compensate themselves in symmetrically impinging pulse intensities, which are ideally transformed completely into heat and separation energy. This also reduces the shock wave resulting from impact cutting.

Advantageously an acceleration unit is used in the impact and reverse impact arrangement which synchronizes the acceleration of the impact and reverse impact element. Or two acceleration units are synchronized with each other by mutual coupling.

If the impact element comprises a shape tapered towards the impact surface of the impact element, the deceleration impulse of the impact element towards the impact surface is concentrated and amplified.

In the cutting unit according to claim 25 between a moveable matrix element and a supporting structure for the cutting unit a damping device is arranged between the side opposing to the impact side of the moveable matrix and the supporting structure. By means of the damping element excessive energy from the impact is damped, if the impact energy could not be transformed completely into separation energy and heat energy. By means of an annular spring as a damping device the excessive energy is advantageously transformed into heat energy within a very short distance. If additionally or alternatively an air gap is provided as damping device and if compressed air is fed into the air gap, contaminations are discharged from the air gap on the one hand and on the other hand the continuous air flow serves for cooling the cutting unit.

If the moveable matrix is supported in a recess having lateral guiding, the air fed into the air gap also causes the reset of the moveable matrix element. This can be assisted in that in the case of the displaced matrix element the air can hardly discharge from the air gap and thus an air pressure is build up which resets the matrix with increased power.

If at least one moveable matrix element is supported in a recess having side boundary walls and if pressurized air is supplied to the side boundary walls, then contaminations are discharged on the one hand and the air cussion serves as air conduction bearing for guiding the moveable matrix element in the recession.

If in the moveable matrix element the cross-section of the opening enlarges from the separation rim to the feeding or removing side of the workpiece, then not the whole workpiece held in the matrix has to undergo the lateral acceleration effected during the impact operation. Thus the impulse energy acting on the cutting location is increased.

The embodiments of the invention are explained by means of drawings which show:

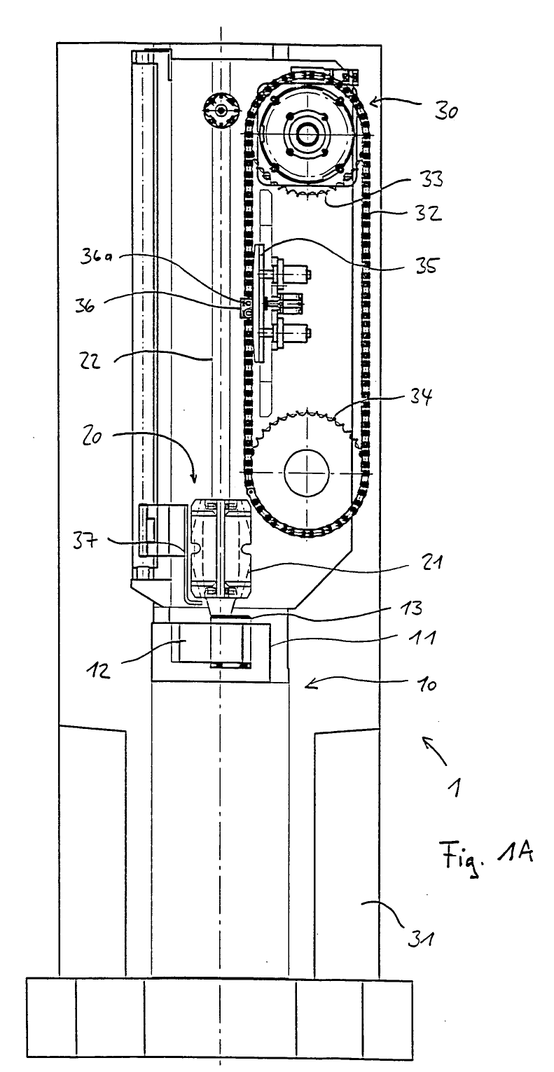

FIG. 1A a schematic front view of an impact cutting machine,

FIG. 1B a partial view of the impact cutting machine while coupling the hammer,

FIG. 1C a partial view of the impact cutting machine on the verge of decoupling the hammer,

FIG. 1D a side view of the impact cutting machine,

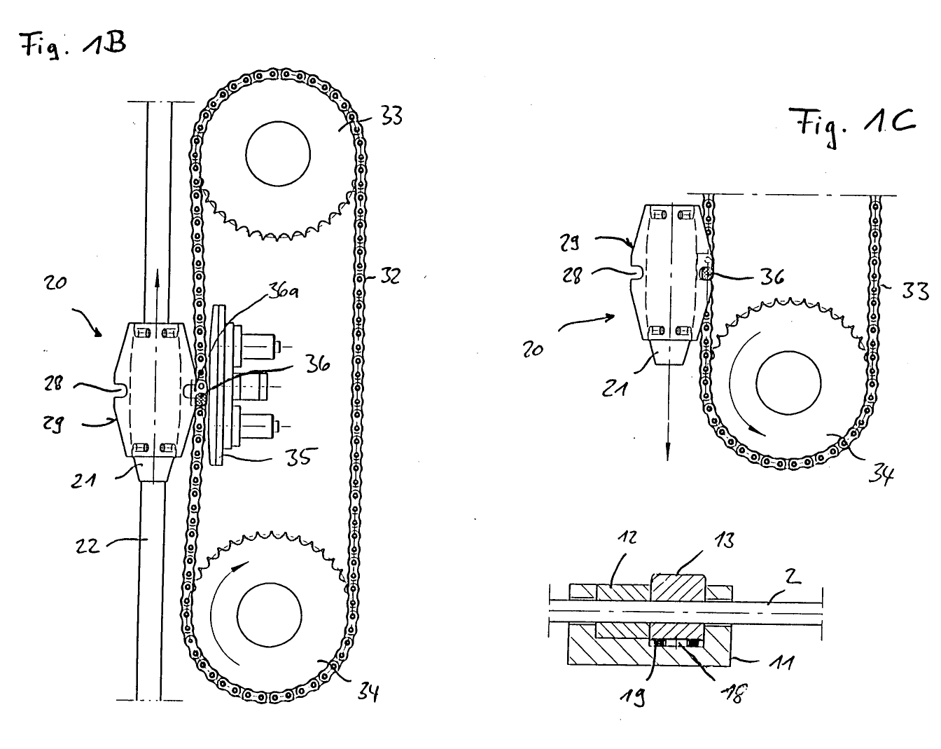

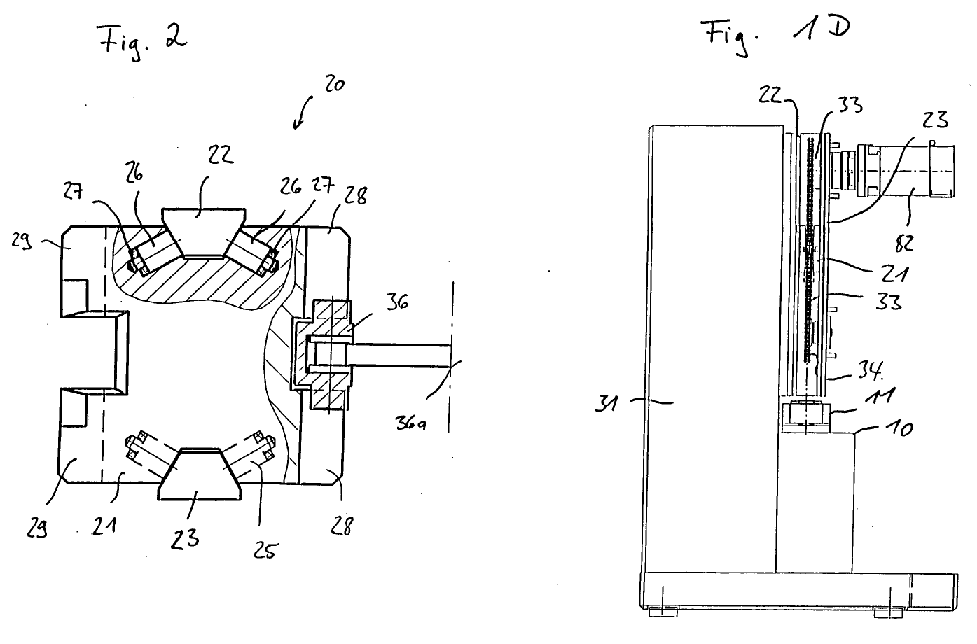

FIG. 2 a schematic cross-sectional top view of a hammer unit,

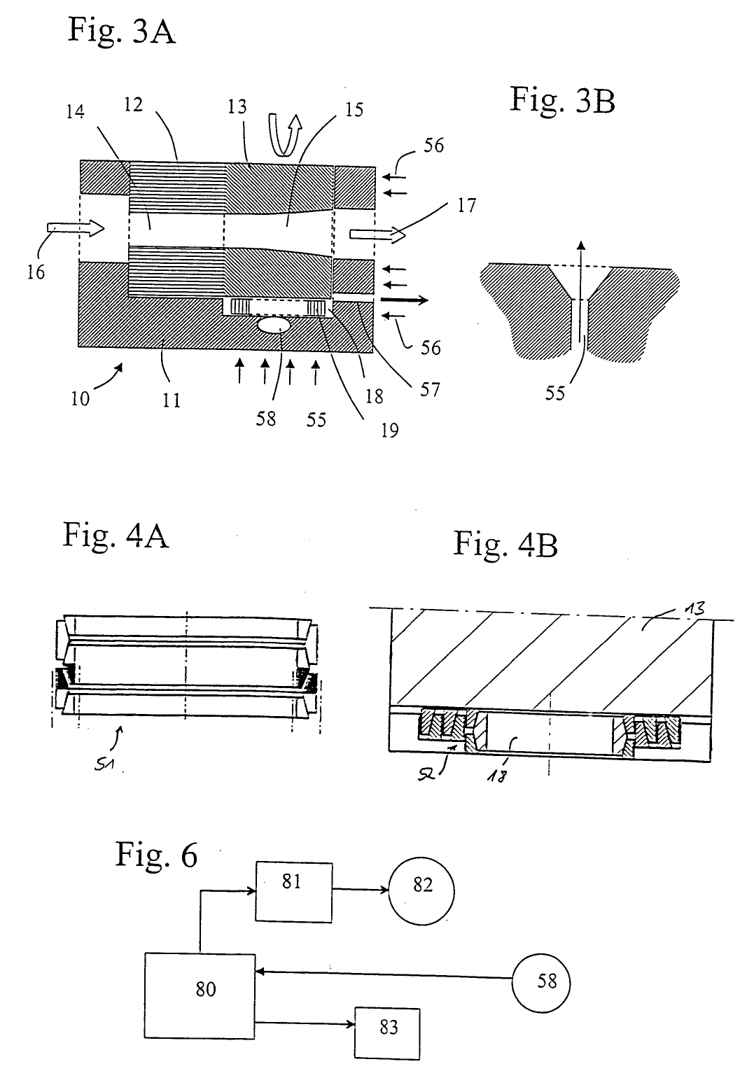

FIGS. 3A and 3B cross-sectional views of an embodiment of a matrix block,

FIGS. 4A and 4B two embodiments of damping elements,

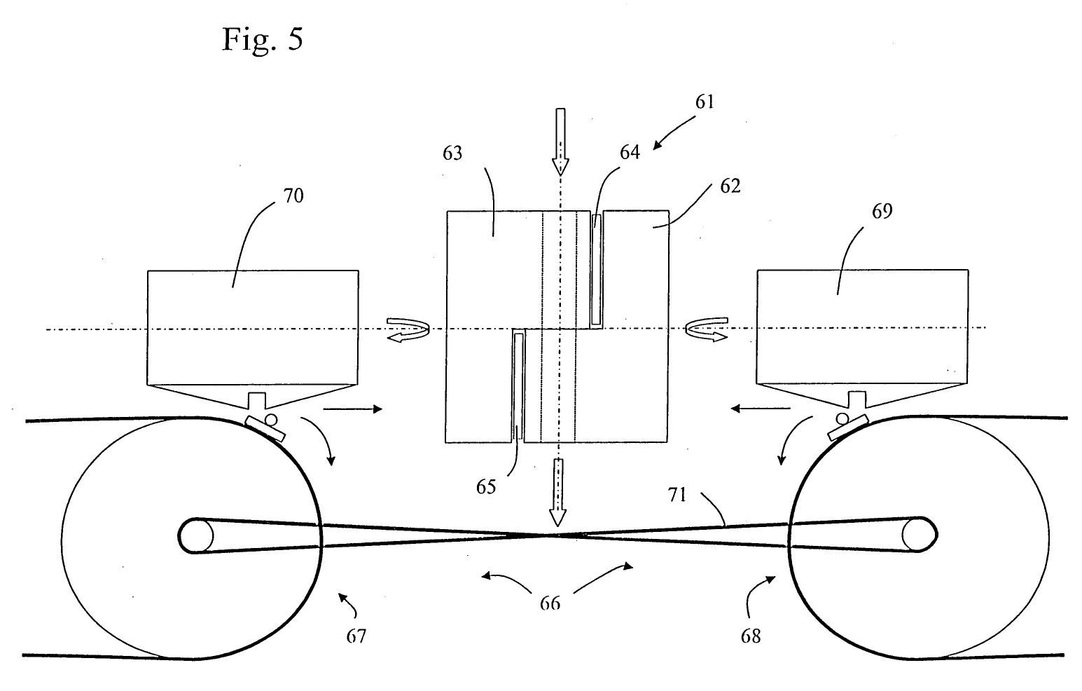

FIG. 5 a schematic side view of a double impact cutting machine, and

FIG. 6 a block diagram of the control means of an impact cutting machine.

FIG. 1A schematically shows a front view of the construction of an impact cutting machine 1. The workpiece 2 to be cut (FIG. 1C) is clamped in a matrix block 10 and is cut there by carrying out impacts by means of the hammer unit 20. A percussion hammer 21 of the hammer unit 20 is accelerated by an acceleration unit 30. The matrix block 10 rests on a supporting structure 31 to which also a guiding 22 of the hammer unit 20 and the acceleration unit 30 is connected. Parts of the supporting structure 31 are formed of mineral cast which comprises besides the high supporting feature a particularly good damping against vibration and shock wave propagation. Vibration or shock wave propagation from the matrix block to the workhall floor and respectively the acceleration unit 30 and the hammer unit 20 is therefore avoided. Vice versa, vibration propagation from the hammer unit 20 is highly damped.

In the acceleration unit 30 runs a chain 32 over an upper driving wheel 33 and a lower deflecting wheel 34. The upper driving wheel 33 is driven by a NC-controlled servodrive 82 (FIG. 1D) which enables momentary, very high accelerations. The chain 32 carries a slide 36a from which protrudes a carrier 36 which in turn grips in a recess 28 of the hammer 21. A chain guiding 35 next to the chain 32 runs at least over a part of the acceleration distance. The chain guiding comprises an actuator, here a pneumatic actuator, which perpendicularly positions to the chain a chain guiding rail running next to the chain. In the acceleration phase the chain guiding rail is positioned next to the chain (as shown in FIG. 1A) and limits or damps lateral chain deflections arising perpendicularly to the pulling direction, which could be evoked by the acceleration and the subsequent slowing down action, respectively. The contact surface of the chain guiding rail to the chain is provided with a sliding material.

For inserting the carrier 36 into the recess 28 during the coupling of the hammer 21, the chain guiding is pulled back so that the chain can be laterally deflected: FIG. 1B shows a partial view of the impact cutting machine in a phase on the verge of coupling the carrier 36 into the recess 28 of the hammer. After the impact the hammer 21 is lifted by a lifting unit 37 to the position shown in FIG. 1B and the slide 36a is driven upwards by means of the chain 33. FIG. 1C shows a phase during acceleration, while the carrier 36 completely grips into the recess 28 of the hammer 21.

In an embodiment not shown herein the chain 32 is alternatively or additionally driven by the lower wheel 34, so that the chain between the lower and the upper wheel 33, 34 is under tension and stiffened over the acceleration distance.

FIG. 2 shows a schematic cross-sectional top view of the hammer unit 20. The hammer 21 is guided in a first and second guiding rail 23, 24 of the guiding 22. The hammer 21 does not directly contact the guiding rails 23, 24, but is slidingly guided on the rails 22, 23 via sliding blocks 26 resting in recesses 25. The sliding blocks 26 are for example metal matrixes in which molybdenum sulfide (MoS) is incorporated as lubricant. Between the back of the sliding blocks 26 and the bottom of the recess 25 damping elements 27 are arranged which transform impulses of the hammer 21 into heat and thereby damp the transmission of vibrations or shock waves from the hammer 21 to the rails 23, 24. In a further embodiment not shown herein, damping elements may also be associated to either all or a part of the sidewalls between the sliding block 26 and the recess 25. The carrier 36 of the acceleration unit 30 comprises lateral projections which are connected to the slide 36a via a connecting element. The two lateral projections of the carrier 36 grip into the two lateral recesses 28 at the hammer 21. Ramps 29 adjoin to the sidewalls of the recesses 28, wherein the projections of the carrier 36 slide over the ramp 29 when moving back the hammer 21 from the lower position (at the matrix block 10). For this, the chain 32 and the slide 36a are deflected (FIG. 1B) and after reaching the recess 28 the projections of the carrier 36 snap into the recess 28 so that the hammer 21 can be lifted by the acceleration unit 30 and moved back into its starting position.

FIG. 3A is a cross-sectional view of a tool holder 11 of the matrix block 10. In a top down running recess of the tool holder 11 a stationary matrix 12 and a moveable matrix 13 are exchangeably inserted. The matrix pair 12, 13 has a first and a second passage 14, 15, wherein the cross-section of each is adapted to the workpiece to be processed. For cutting a workpiece of a different nature (cross-section, material of the workpiece, form of the workpiece etc.) the matrix pair 12, 13 is correspondingly exchanged in the tool holder 11. By means of mounting elements not shown the stationary matrix 12 is held fixedly in the tool holder 11, while below the moveable matrix 13 a recess 18 is arranged, which enables a little downward movement of the matrix 13 during the impact. The hammer 21 and/or the matrices 12, 13 are formed of a particularly impact resistant steel, for example the product having the identification number 1.2379 (special steel) of the company STM-Stahl. The arrows 16 and 17 indicate the entrance side and the exit side of the workpiece 1 at the tool holder 11, wherein of course a reverse introducing and removing of the workpiece is also possible. The curved arrow symbolizes the performance of the impact to the moveable matrix 13.

The second passage 15 of the moveable matrix 13 opens from the intersection to the input and output 17, respectively. Thereby the workpiece is held free of clearance in the area of the cutting edge, while for longer workpieces a displacement of the end of the workpiece outside the matrix 13 is avoided during impact cutting. Thereby the mass to be accelerated during the impact is reduced and the required impulse-energy for longer workpieces is widely independent from the length of the workpiece to be separated.

In the recess 18 a damping element 19 is arranged which absorbs the impact impulse or the part of the impact impulse, which has not been transformed into separation and deformation energy during the impact, and transforms it into heat. The damping element 19 countervails with very high power against the displacement of the moveable matrix 13, so that it is completely slowed down within a very short deflection distance, even if there is excessive energy. FIGS. 4A and 4B show two embodiments of the damping element 19. The first spring ring 51 is formed of five annular ring elements wedged into each other. The friction spring thereby formed transforms the displacement of the rings into heat energy by friction and causes an efficient damping of the moveable matrix 13. A second spring ring arrangement is indicated by reference numeral 52, in which the rings are partially positioned on top or below of each other, so that the base area of the recess 18 is further utilized.

After performing an impact onto the moveable matrix element 13 the return of the matrix 13 is carried out by the damping element 19. The retraction may alternatively or additionally be carried out by generating a pneumatic cussion below the moved matrix element 13, as shown in FIG. 3A. As symbolized by the arrows 55, compressed air is introduced into the recess 18, which discharges through an outlet 57 when the matrix element 13 is lifted. When the matrix element 13 is lowered the air outlet 57 is completely or partially closed so that due to the compressed air introduced through the lower pneumatic passages 55 in the recess 18 a pressure is generated, which re-lifts the matrix 13 in its starting position. The compressed air flow from the pneumatic passages 55 through the recess 18 prevents contaminations from penetrating into the recess 18 and cools the damping element 19 and the lower matrix side, respectively. In another embodiment air gaps are formed on at least one side wall between the tool holder 11 and the moveable matrix 13, into which air flows via lateral air passages 56. The compressed air between the moveable matrix and the tool holder 11 aligns the moveable matrix 13 and enables lateral sliding during the impact and afterwards a retraction of the moveable matrix 13 into the starting position.

In addition a sensor 58 is associated to the tool holder 11, which detects the vibrations of the tool holder 11 and/or measures the air pressure in the recess 18. Thus, the presence and the level of the vibrations can be measured while performing the impact. The level of the vibrations is a measurement for the excessive impact energy which has not been transformed for the separation of the workpiece. As excessive energy has to be preferably avoided, the signal of the sensor 58 is used for optimization of the parameters of the impact cutting machine as well as for controlling the function of impact cutting. As shown in FIG. 3A, if a pressure sensor associated to the recess 18 is used, also the proper retraction of the moveable matrix 13 can be checked while introducing compressed air into the recess 18, wherein after the retraction of the matrix 13 into the starting position the pressure within the recess 18 has to fall to a given value.

FIG. 3B shows an embodiment of a pneumatic passage 55 and/or 56, wherein several of these bores are provided in the tool holder 11 distributed over the surface area, so that a constant air cussion is formed. If a hole diameter of several micrometers (10-200 μm) is used, the compressed air can not discharge fast enough through the bores 55, 56 while compressing the air in the gaps or in the recess 18 and during deflection a high air pressure is formed in the gaps and/or the recess 18.

FIG. 5 schematically shows the arrangement of a double impact cutting machine 60. In this arrangement a cutting unit 61 is supported floatingly or at least deflectably in both directions of the impact direction in a tool holder not shown herein. A first and a second matrix 62, 63 are displaceable against each other and in relation to the tool holder. As shown in FIG. 5 the workpiece is introduced from above and the cutted parts are removed downward. The orientation herein is only exemplified. The matrixes 62, 63 are supported against each other over a first and a second damping element 64, 65. A first and a second hammer 69, 70 are preferably accelerated against each other on a common barycentric axis, wherein also the barycentric axis of the matrixes 62, 63 advantageously complies with that of the hammers 69, 70. An acceleration unit 66 accelerates the first and second hammer over a first and second acceleration distance 67, 68. The acceleration of the hammers 69, 70 is such that their impulses are equal. For an easier dimensioning and setting the weights of the hammers 69, 70 are preferably equal. By means of the belt 71 it is symbolically indicated that the acceleration over the first and second acceleration distance 67, 68 is carried out synchronously to each other. Thereby a common drive for example may be used which couples both acceleration lines via a gear, a chain or the like. The decoupling of the hammers 69, 70, the guiding of the hammers and/or the acceleration over the acceleration distances 67, 68 is advantageously carried out in accordance with the above embodiments in respect of the single acceleration line of FIG. 1.

FIG. 6 schematically shows the control of the impact cutting machine 1 (or 61+66) by means of a control unit 80. Operation parameters, such as the type of the matrix and the material to be cut, are input into the control unit, so that it is possible to access given sets of parameters each including a standard setting in accordance with the matrixes and the material to be cut. The control unit 80 activates a power controller 81 providing the electrical power for driving a motor 82 in order to drive the upper driving wheel 33 for example. The control unit 80 thereby sets the starting position for the acceleration of the hammer 21 and controls the level of acceleration (where applicable temporally variable over the acceleration distance), where applicable the end point of the acceleration (so that already before decoupling a relaxation between the hammer 21 and carrier 36 is effected) and the moving back of the carrier for retracting the hammer 21 in its starting position for the next impact operation. Further, by means of the control unit 80 a transport unit 83 is activated which causes the feeding of the raw material to be cut into the tool holder 11. For optimizing the impact process the sensor signal of the sensor 58 is fed to the control unit 80, so that by means of the excessive energy level (see above) the control unit can optimize the process by setting the acceleration parameters until the excessive energy is minimal.

The acceleration of the hammer 21 (the same applies for the hammers 69, 70) is carried out in that the hammer and carrier 36, respectively, is in the starting position and the acceleration operation starts by means of the motor 82. Therein, also with small required impact impulses (for example with a thin workpiece) it is possible to start from a maximal retraction position in order to be able to accelerate over a long acceleration distance with low acceleration power. If however a high impact frequency is required, an acceleration distance as short as possible (low starting position of the hammer 21) is chosen in accordance with the required impact impulse, so that the acceleration and retraction operation can be carried out in a short time. A high acceleration acts then on the hammer.

On the level of the lower deflecting wheel the deflection of the chain 32 causes the slide 36a being pulled back and thus the carrier 36 being retracted from the recess 28 (e.g. FIG. 5). Just after a short deflection of the slide 36a (small pivoting angle at the deflecting wheel 34) the carrier 36 is pulled out of the recess 28 and the movement of the hammer 21 unimpededly continues towards the matrix block 10. For lifting the hammer 21 into the starting position after performing the impact, the hammer 21 is lifted by the lifting mechanism 37 shown in FIG. 1A, either synchronously with moving the carrier 36 backward, so that by lifting the hammer 21 and by moving up the carrier 36 the carrier grips into the recess 28, or the hammer 21 is lifted by the lifting mechanism to a level above the lower deflecting wheel 34, so that the projections of the carrier 36 slide over the lower ramp 29 and by pushing apart the chain 32 (phase FIG. 1B) the projections of the carrier snap into the recess 28 following the ramp. As mentioned above, in this phase the chain guiding rail is pulled back from the base line of the chain 32 by means of the actuator of the chain guiding 35. After the carrier 36 engages the recess 28, the hammer 21 can be moved back into the starting position by means of the acceleration unit 30.

### List of Reference Signs

1 impact cutting device
10 matrix block
11 tool holder
12 stationary matrix
13 moveable matrix
14 first passage
15 second passage
16 input side
17 output side
18 recess
19 damping element
20 hammer unit
21 hammer
22 guiding
23 first guiding rail
24 second guiding rail
25 recess
26 sliding block
27 damping element
28 recess
29 ramp
30 acceleration unit
31 supporting structure
32 chain
33 driving wheel
34 deflecting wheel
35 chain guiding
36a slide
36 carrier
37 lifting unit
51 first spring ring
52 second spring ring
55 pneumatic passage
56 pneumatic passage
57 air outlet
58 sensor
60 double impact cutting machine
61 cutting unit
62 first matrix
63 second matrix
64 first damping element
65 second damping element
66 acceleration unit
67 first acceleration distance
68 second acceleration distance
69 first hammer
70 second hammer
71 belt
80 control unit
81 power controller
82 motor
83 transport unit

1. Impact cutting device having at least one cutting unit for processing workpieces, an acceleration unit and an impact element that can be accelerated towards the cutting unit, wherein the improvement comprises, a detachable coupling means connecting the impact element and the acceleration unit over an acceleration distance, the detachable coupling means for decoupling the impact element from the acceleration unit after having been accelerated by the acceleration unit and prior to striking the cutting unit.

2. Device according to claim 1, wherein the acceleration unit has adjustable acceleration means.

3. Device according to claim 2, characterized in that the acceleration means comprises a carrier coupling the impact element to the acceleration unit at least over an acceleration distance.

4. Device according to claim 3, characterized in that the carrier engages with a recess of the impact element at least over the acceleration distance.

5. Device according to claim 3, characterized in that a guiding means of the carrier runs parallel to the track of the impact element at least over the acceleration distance and wherein the guiding means of the carrier deviates from the track of the impact element for decoupling the carrier from the impact element.

6. Device according to claim 3, characterized in that the carrier is arranged on a striplike element.

7. Device according to claim 6, characterized in that the section of the cutting unit comprises at least one deflecting means for deflecting the striplike element.

8. Device according to claim 7, characterized in that the striplike element is endless and guided over at least two deflecting elements wherein at least one of the deflecting elements is driven.

9. Device according to claim 6 wherein the striplike element is a belt.

10. Device according to claim 1, characterized in that the impact element is supported in a guiding device.

11. Device according to claim 10, characterized in that the impact element is connected to the guiding device via at least one sliding element.

12. Device according to claim 11, characterized in that the at least one sliding element is moveably supported in a recess on the impact element and a damping element is arranged between the sliding element and the recess.

13. Device according to claim 1, characterized in that the at least one cutting unit is supported on a mineral cast supporting structure.

14. Device according to claim 1, characterized by a counter impact element having means for reverse acceleration of the impact element towards the cutting unit.

15. Device according to claim 1, characterized in that the impact element comprises a shape tapered towards the impact surface.

16. Device according to claim 1, wherein the cutting unit comprises two matrix element means for gripping a workpiece to be processed, wherein at least one of the matrix element means is moveably supported relative to the other matrix element, characterized in that a damping unit is arranged between a support and the at least one moveable matrix element opposite to the impinging side of the moveable matrix element.

17. Cutting unit according to claim 16, characterized in that the damping unit comprises at least one annular spring.

18. Method for accelerating an impact element to a cutting unit for processing workpieces comprising a sequence of steps wherein, prior to the impingement of an impact element on a cutting unit, a moving phase being substantially free of force is subsequent to an acceleration phase for the impact element.

19. Cutting unit for an impact cutting device comprising two matrix elements for gripping a workpiece to be processed, wherein at least one of the matrix elements is moveably supported relative to the other matrix element, characterized in that a damping unit is arranged between a support and the at least one moveable matrix element.
